(19) United States
(12) Patent Application Publication
(10) Pub. No.: US 2015/0261000 A1
(43) Pub. Date: Sep. 17, 2015

(54) 3D IMAGE DISPLAYING OBJECT, PRODUCTION METHOD, AND PRODUCTION SYSTEM THEREOF

(71) Applicant: FUJITSU LIMITED, Kawasaki-shi (JP)

(72) Inventor: Toshiro OHBITSU, Akishima (JP)

(21) Appl. No.: 14/728,698

(22) Filed: Jun. 2, 2015

Related U.S. Application Data
(63) Continuation of application No. PCT/JP2012/083129, filed on Dec. 20, 2012.

(51) Int. Cl. G02B 27/22; G03B 35/24; H04N 13/04

(52) U.S. Cl. CPC G02B 27/2214; H04N 13/0447; H04N 13/0404; G03B 35/24

(57) ABSTRACT

A stereoscopic image including a right eye image and a left eye image is printed on a print member. A lenticular lens converges a reflected light from the right eye image and a reflected light from the left eye image at different view zones by means of an array of a plurality of cylindrical lenses. One or more optical members are located between the print member and the lenticular lens. Each optical member includes a plurality of optical elements corresponding to pixels of color components of the right eye image and pixels of color components of the left eye image, which are arrayed in an array direction of the cylindrical lenses. Each optical element bends a light path of the reflected light that comes from a corresponding pixel of the stereoscopic image and enters into the lenticular lens, in the array direction.

### CROSS-REFERENCE TO RELATED APPLICATION

This application is a continuation application of International Application PCT/JP2012/083129 filed on Dec. 20, 2012 which designated the U.S., the entire contents of which are incorporated herein by reference.

### FIELD

The embodiments discussed herein relate to a 3D image displaying object, a production method, and a production system thereof.

### BACKGROUND

There is 3D (three-dimensional) image displaying objects having a lens sheet laminated on the surface of a printed object, so as to enable a viewer to visually perceive a 3D image. The full depth method is a representative method for displaying a printed object three-dimensionally. In the full depth method, a stereoscopic image including an interlaced right eye image and left eye image is printed, and a lenticular lens sheet including an array of a plurality of cylindrical lenses is laminated on the printed surface. The lenticular lens enables the right eye image and the left eye image to be perceived at viewer's right eye and left eye respectively, so that the viewer can visually perceive a 3D image.

Also, as an example of display technology of 3D images, there is a display device equipped with an image conversion unit which includes a plurality of prisms arrayed in the direction the lenticular lens extends. In addition, there is a display device having a flat structure created by filling the lens surface of a lenticular lens sheet with a low refractive index layer material having a lower refractive index than the material of the lenticular lens sheet.

See, for example, Japanese Laid-open Patent Publication Nos. 11-95168, 2010-256852, and 2011-128636.

When fabricating a 3D image displaying object using a printed object, a lenticular lens and a printed image on the printed object need to be positioned accurately relative to each other in the array direction of cylindrical lenses. When positional misalignment exists, the viewer does not recognize the printed image as a 3D image.

However, a printer prints an image at an arbitrary position on a printed surface, depending on designer's intention. This varies a reference position for laminating the lenticular lens on the printed surface, and increases a probability of positional misalignment between the lenticular lens and the printed image.

### SUMMARY

According to one aspect, there is provided a 3D image displaying object including: a print member on which a stereoscopic image including a right eye image and a left eye image is printed; a lenticular lens including an array of a plurality of cylindrical lenses for converging a reflected light from the right eye image and a reflected light from the left eye image at respective different view zones; and one or a plurality of optical members located between the print member and the lenticular lens and including a plurality of optical elements that correspond to pixels of color components of the right eye image and pixels of color components of the left eye image which are arrayed in an array direction of the cylindrical lenses, wherein each of the optical elements bends a light path of the reflected light that comes from a corresponding pixel of the stereoscopic image and enters into the lenticular lens, in the array direction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a 3D image displaying object according to a first embodiment;

FIG. 2 illustrates light paths of reflected light from a stereoscopic image;

FIG. 3 is a cross-sectional view illustrating an exemplary configuration of a 3D image displaying object according to a second embodiment;

FIG. 4 illustrates an exemplary configuration of a diffraction grating sheet;

FIG. 5 illustrates an example of light paths when there is no positional misalignment between a stereoscopic image and a lens sheet;

FIG. 6 illustrates an example of light paths when there is positional misalignment between a stereoscopic image and a lens sheet;

FIG. 7 illustrates an example of light paths when a diffraction grating sheet is inserted in the configuration of FIG. 6;

FIG. 8 illustrates an example of light paths when a plurality of diffraction grating sheets are inserted;

FIG. 9 illustrates a position relationship between diffraction grating sheets with respect to diffraction gratings of each color component;

FIG. 10 illustrates a transmissive blazed diffraction grating;

FIG. 11 illustrates an example of view zones of a right eye image and a left eye image;

FIG. 12 is a diagram for describing a view zone formed by a lenticular lens;

FIG. 13 illustrates an example of marker images which are used in producing 3D image displaying objects;

FIG. 14 illustrates how the marker images are viewed under conditions of positional misalignment amount;

FIG. 15 illustrates a relationship between colors of the marker images and positional misalignment amounts in a pilot displaying object;

FIG. 16 illustrates an exemplary configuration of a production system for producing 3D image displaying objects; and

FIG. 17 is a flowchart illustrating an example of a production process for producing 3D image displaying objects.

### DESCRIPTION OF EMBODIMENTS

Several embodiments will be described below with reference to the accompanying drawings, wherein like reference numerals refer to like elements throughout.

### First Embodiment

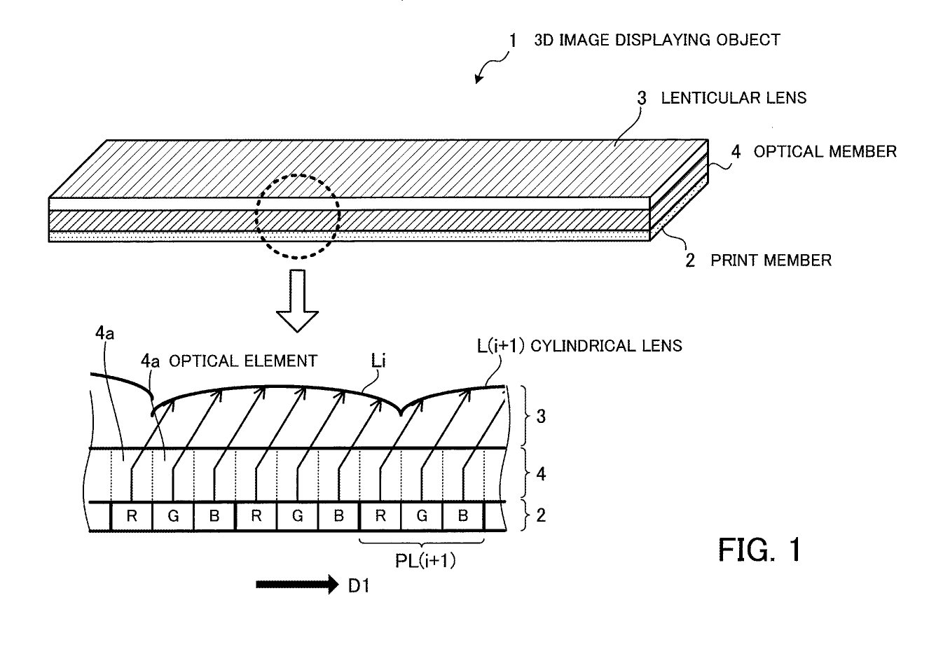

FIG. 1 illustrates an exemplary configuration of a 3D image displaying object according to the first embodiment. As illustrated in FIG. 1, the 3D image displaying object 1 is structured to include a layer of an optical member 4 having a function for bending light paths and arranged between a print member 2 and a lenticular lens 3.

The print member 2 is a medium on which an image is printed on its surface, and is for example a sheet of paper, a plastic film, a plastic plate, etc. On the print member 2, a stereoscopic image including a right eye image and a left eye image is printed.

The lenticular lens 3 includes an array of a plurality of cylindrical lenses. The lenticular lens 3 converges reflected light from the right eye image and reflected light from the left eye image at respective different view zones, using the cylindrical lenses. A viewer visually perceives the stereoscopic image of the print member 2 via the lenticular lens 3, in such a way that the right eye visually perceives the right eye image, and the left eye visually perceives the left eye image, in order to recognize a 3D image.

The optical member 4 includes a plurality of optical elements 4a corresponding to pixels of color components of the right eye image and pixels of color components of the left eye image which are arrayed in an array direction of the cylindrical lenses (direction D1 from left to right in FIG. 1). Each of the optical elements 4a bends a light path of reflected light that comes from a corresponding pixel of the stereoscopic image and enters into the lenticular lens 3, in the direction D1.

The optical member 4 changes the light paths of reflected light from the stereoscopic image, to cancel positional misalignment in the direction D1 between the stereoscopic image on the print member 2 and the lenticular lens 3 which remains after the print member 2 and the lenticular lens 3 are aligned to each other. Accordingly, when there is no positional misalignment between the stereoscopic image and the lenticular lens 3 in the direction D1, the optical member 4 is needless to be inserted especially.

Here, the stereoscopic image will be described. Each of the right eye image and the left eye image of the stereoscopic image are composed of a collection of pixels of a plurality of color components of a same number. In the following description, the minimum unit of each color component in the right eye image and the left eye image is referred to as “pixel”. In an example of FIG. 1, both of the right eye image and the left eye image include pixels of R (Red) component, G (Green) component, and B (Blue) component. Note that, in the following description, a pixel of R component, a pixel of G component, and a pixel of B component are referred to as “R pixel”, “G pixel”, and “B pixel”, respectively.

Also, the minimum unit of pixels of color components for expressing one color in the right eye image and the left eye image is referred to as “pixel group”. In an example of FIG. 1, one pixel group includes a pixel of R component, a pixel of G component, and a pixel of B component, which are adjacent to each other in the direction D1.

In the stereoscopic image, the right eye image and the left eye image are both divided into rectangular strips of individual pixel groups arrayed in the direction D1. The divided regions of the right eye image and the divided regions of the left eye image are alternatingly located in the direction D1.

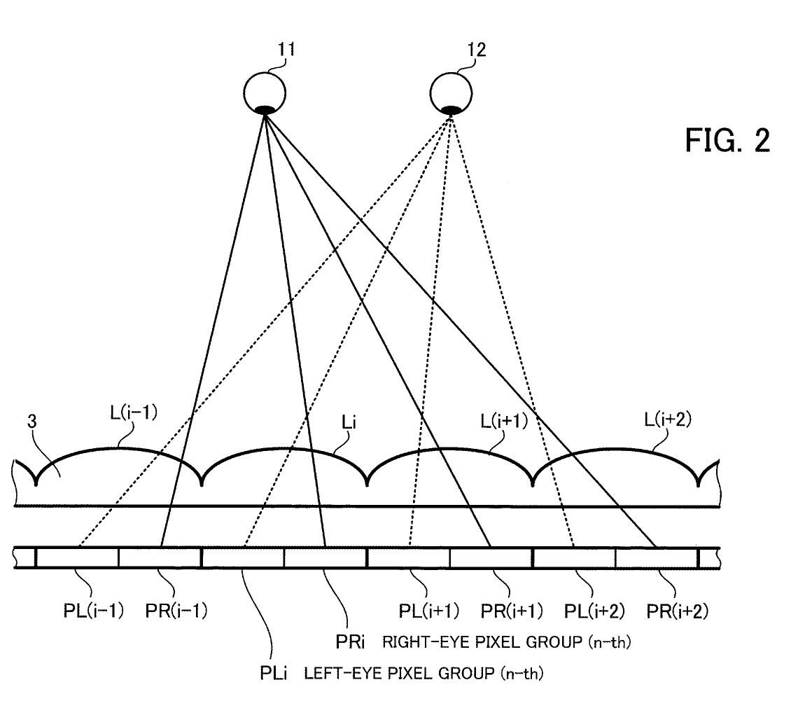

Next, FIG. 2 illustrates light paths of reflected light from the stereoscopic image. FIG. 2 illustrates an example of light paths when the optical member 4 is not inserted between the print member 2 and the lenticular lens 3. Note that, in FIG. 2, “i” indicates a sequential number given to each pixel group of the right eye image and the left eye image, in the order along the direction D1 from a starting pixel group.

The cylindrical lenses are arranged such that one cylindrical lens corresponds to two pixel groups that are adjacent to each other in the direction D1. In the example of FIG. 2, an (i−1)th cylindrical lens L(i−1) is located over an (i−1)th right-eye pixel group PR(i−1) and an (i−1)th left-eye pixel group PL(i−1). Also, an i-th cylindrical lens Li is located over an i-th right-eye pixel group PRi and an i-th left-eye pixel group PLi. An (i+1)th right-eye pixel group PR(i+1), an (i+1)th left-eye pixel group PL(i+1), and an (i+1)th cylindrical lens L(i+1) are arranged in the same way. Further, an (i+2)th right-eye pixel group PR(i+2), an (i+2)th left-eye pixel group PL(i+2), and an (i+2)th cylindrical lens L(i+2) are arranged in the same way.

In this case, a viewer visually perceives the stereoscopic image as described below, for example. The viewer visually perceives the right-eye pixel group PR(i−1) via the cylindrical lens L(i−1) with the right eye 11, and visually perceives the left-eye pixel group PL(i−1) via the cylindrical lens L(i−1) with the left eye 12. Also, the viewer visually perceives the right-eye pixel group PRi via the cylindrical lens Li with the right eye 11, and visually perceives the left-eye pixel group PLi via the cylindrical lens Li with the left eye 12. In this way, the viewer visually perceives the right eye image with the right eye 11, and the left eye image with the left eye 12, to recognize the stereoscopic image as a 3D image.

The lenticular lens 3 converges the right eye image and the left eye image at respective different view zones, so that the right eye 11 and the left eye 12 positioned in the respective view zones visually perceive the right eye image and the left eye image, respectively. As described above, to allow the viewer to recognize the stereoscopic image as a 3D image, the stereoscopic image and the lenticular lens 3 need to be aligned correctly in the direction D1. When there is positional misalignment between the stereoscopic image and the lenticular lens 3 in the direction D1, the viewer does not recognize the stereoscopic image as a 3D image.

However, a printer prints the stereoscopic image at an arbitrary position on the printed surface of the print member 2, depending on designer's intention or other reasons. Hence, a reference position for laminating the lenticular lens 3 on the printed surface is different, depending on the content of the stereoscopic image (i.e., print image data input into a printer). Also, even when the stereoscopic images have a same content, print positions of the stereoscopic images on the print surface can be slightly different from each other, depending on a method for adjusting a printer, a model of a printer, individual variability of printers of a same model, etc. Accordingly, a constant position relationship between the lenticular lens 3 and the print member 2 is not sufficient for preventing positional misalignment between the lenticular lens 3 and the stereoscopic image.

The following description refers to FIG. 1 again. As described above, each optical element 4a of the optical member 4 changes the light path of reflected light that comes from a corresponding pixel and enters into the lenticular lens 3, in the direction D1. Thus, even when there is positional misalignment between the stereoscopic image and the lenticular lens 3, a reflected light from each pixel of the stereoscopic image enters into a correct cylindrical lens corresponding to the pixel. As a result, the viewer recognizes the stereoscopic image as a 3D image.

In the lower portion of FIG. 1, the stereoscopic image is misaligned by one pixel in the opposite direction to the direction D1, for example. For example, as for the pixels of the (i+1)th left-eye pixel group PL(i+1), the reflected lights from G pixel and the B pixel enter into the (i+1)th cylindrical lens L(i+1), but a reflected light from R pixel incorrectly enters into the i-th cylindrical lens Li without the inserted optical member 4 in the depicted misaligned state. In this case, the viewer does not visually perceive a correct 3D image, but an image including crosstalk with a feeling of strangeness.

In contrast, when the optical member 4 is inserted between the print member 2 and the lenticular lens 3, a reflected light from R pixel of the left-eye pixel group PL(i+1) correctly enters into the cylindrical lens L(i+1). That is, even when there is positional misalignment between the stereoscopic image and the lenticular lens 3 in the direction D1, the viewer visually perceives a 3D image.

An amount of change of light paths by the optical member 4 may be decided according to an amount of positional misalignment between the stereoscopic image and the lenticular lens 3. For example, there are prepared a plurality of optical members that change light paths by different amounts, such as an optical member that shifts a position at which a reflected light enters into the lenticular lens 3 by one pixel in the direction D1, and an optical member that shifts by two pixels in the direction D1. Then, an optical member that changes a light path by an amount matching to the positional misalignment amount between the stereoscopic image and the lenticular lens 3 is selected and inserted between the print member 2 and the lenticular lens 3.

Alternatively, only optical members that shift a position at which a reflected light enters into the lenticular lens 3 by one pixel in the direction D1 may be prepared, so that the optical members of a number commensurate with the positional misalignment amount are stacked and inserted between the print member 2 and the lenticular lens 3.

In the following second embodiment, the latter example will be described. Note that, in the second embodiment, a diffraction grating sheet with a plurality of transmissive blazed diffraction gratings is used as an example of the optical member.

### Second Embodiment

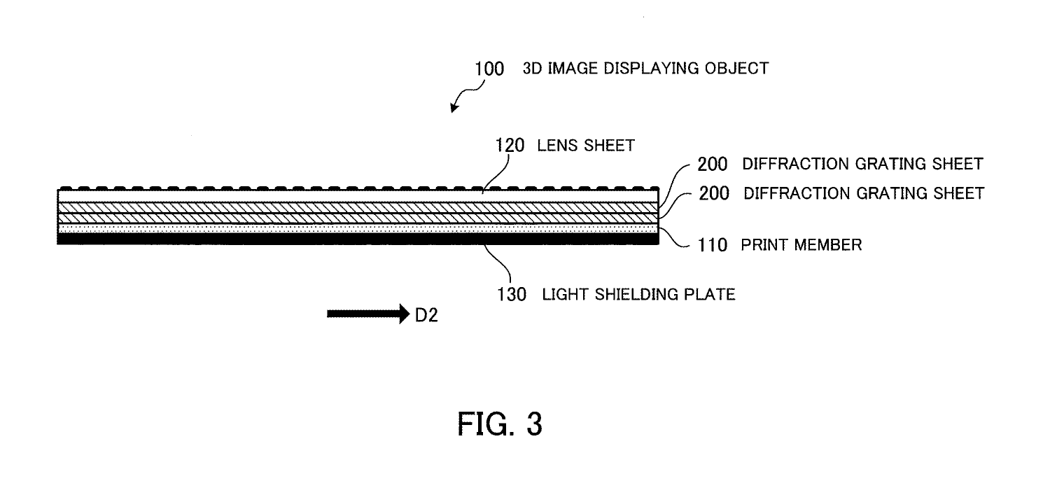

FIG. 3 is a cross-sectional view illustrating an exemplary configuration of a 3D image displaying object according to the second embodiment. The 3D image displaying object 100 illustrated in FIG. 3 includes a print member 110, a lens sheet 120, a light shielding plate 130, and one or a plurality of diffraction grating sheets 200.

On the print member 110, a stereoscopic image including a right eye image and a left eye image is printed in the same way as the print member 2 of FIG. 1. In the present embodiment, the print member 110 is a sheet of paper, for example.

The lens sheet 120 is a lenticular lens sheet, and includes an array of a plurality of cylindrical lenses. The lens sheet 120 is located at the printed surface side of the print member 110. Note that FIG. 3 illustrates a cross-sectional view of the 3D image displaying object 100 as viewed from the extending direction of the cylindrical lenses.

The light shielding plate 130 is located at the opposite side to the printed surface of the print member 110, and prevents a light from entering into the print member 110 from the opposite side of the print member 110.

The diffraction grating sheets 200 are sheet-shaped optical members each having diffraction gratings corresponding to pixels of color components of the stereoscopic image printed on the print member 110. The diffraction grating sheets 200 change light paths of reflected light from the stereoscopic image, in one of array directions of the cylindrical lenses (direction D2 in FIG. 3).

In the present embodiment, the diffraction grating sheets 200 change light paths of reflected light from the print member 110 which enters into the diffraction grating sheets 200, so as to shift by one pixel to the direction D2 the position at which the reflected light enters into an optical member (i.e. another diffraction grating sheet 200 or the lens sheet 120) adjacent in the direction toward the lens sheet 120. Also, the number of the diffraction grating sheets 200 inserted between the print member 110 and the lens sheet 120 is identical with the number of pixels of the positional misalignment amount between the stereoscopic image printed on the print member 110 and the lens sheet 120. When there is no positional misalignment between the stereoscopic image and the lens sheet 120, the diffraction grating sheets 200 are not inserted.

Note that materials of the lens sheet 120 and the diffraction grating sheets 200 are, for example, glass, acrylic, transparent ABS (Acrylonitrile Butadiene Styrene) resin, etc. Also, in an exemplary method for bonding layers in the 3D image displaying object 100, an adhesive agent is applied on the surfaces of the layers, and then the layers are stacked and subjected to thermocompression bonding.

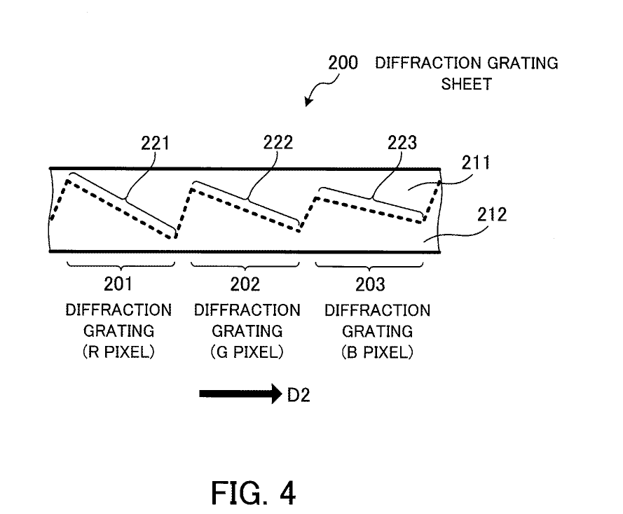

FIG. 4 illustrates an exemplary configuration of the diffraction grating sheet. In the present embodiment, arrangement of pixels of the stereoscopic image printed on the print member 110 is same as that in the stereoscopic image illustrated in the first embodiment. That is, in the stereoscopic image, an R pixel, a G pixel, and a B pixel adjacent in the direction D2 compose a pixel group for expressing one color. Also, the right eye image and the left eye image included in the stereoscopic image are both divided into rectangular strips of individual pixel groups arrayed in the direction D2, and the pixel groups corresponding to the right eye image and the pixel groups corresponding to the left eye image are alternatingly located in the direction D2.

As illustrated in FIG. 4, on the diffraction grating sheet 200, a diffraction grating 201 for R pixel, a diffraction grating 202 for G pixel, and a diffraction grating 203 for B pixel are arrayed in the direction D2. In the present embodiment, the diffraction gratings 201 to 203 are transmissive blazed diffraction gratings, for example. The diffraction grating sheet 200 include regions 211 and 212 formed by materials having different refraction indexes from each other, and diffraction gratings 201, 202, and 203 are formed at boundaries 221, 222, and 223 between the regions 211 and 212, respectively.

As described above, the diffraction grating sheet 200 changes light paths of reflected light that comes from the print member 110 and enters into the diffraction grating sheet 200, so as to shift by one pixel to the direction D2 the position at which the reflected light enters into an optical member (i.e. another diffraction grating sheet 200 or the lens sheet 120) adjacent in the direction toward the lens sheet 120. The diffraction gratings 201, 202, and 203 change light paths of different wavelengths, and therefore the slopes of the boundaries 221, 222, and 223 in the gratings 201, 202, and 203 are different from each other.

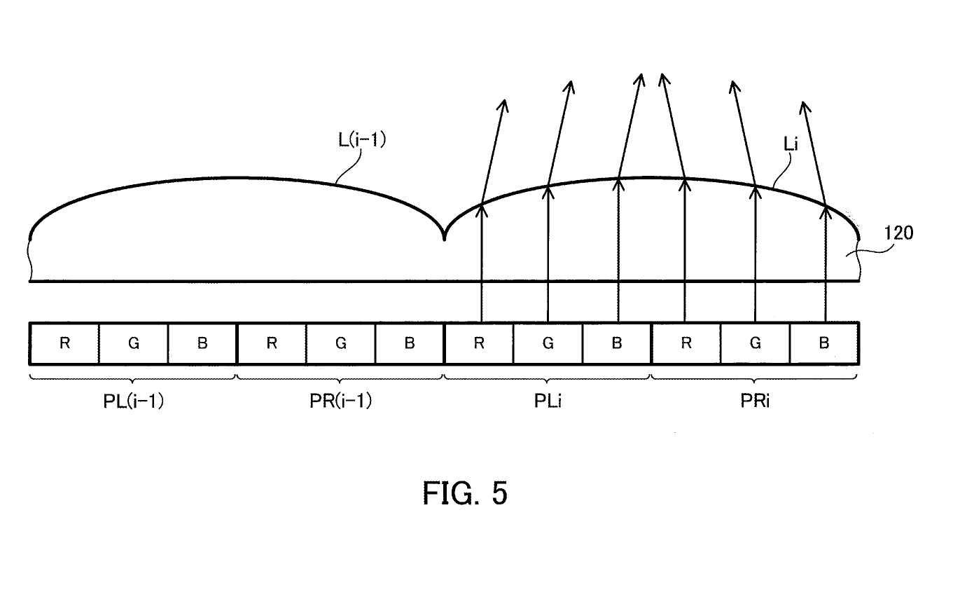

Next, light paths of reflected light from the stereoscopic image will be described with reference to FIGS. 5 to 8. Note that, in the present embodiment, the correspondence relationship between the pixels of the stereoscopic image and the cylindrical lenses of the lens sheet 120 is same as the correspondence relationship between the pixels of the stereoscopic image and the cylindrical lenses of the lenticular lens 3 (refer to FIG. 1) in the first embodiment. Thus, in the following description, the same reference signs as those in FIG. 2 are used for pixel groups of the stereoscopic image and cylindrical lenses of the lens sheet 120.

First, FIG. 5 illustrates an example of light paths when there is no positional misalignment between the stereoscopic image and the lens sheet. As illustrated in FIG. 5, when there is no positional misalignment between the stereoscopic image and the lens sheet 120, an (i−1)th cylindrical lens L(i−1) is located over an (i−1)th left-eye pixel group PL(i−1) and an (i−1)th right-eye pixel group PR(i−1), and an i-th cylindrical lens Li is located over an i-th left-eye pixel group PLi and an i-th right-eye pixel group PRi. In this state, for example, reflected light from the left-eye pixel group PLi and the right-eye pixel group PRi enters into the corresponding cylindrical lens Li. Thereby, the reflected light from the left-eye pixel group PLi and the right-eye pixel group PRi are converged at a predetermined left-eye view zone and right-eye view zone respectively, and a viewer visually perceives the left-eye pixel group PLi and the right-eye pixel group PRi with the left eye and the right eye respectively.

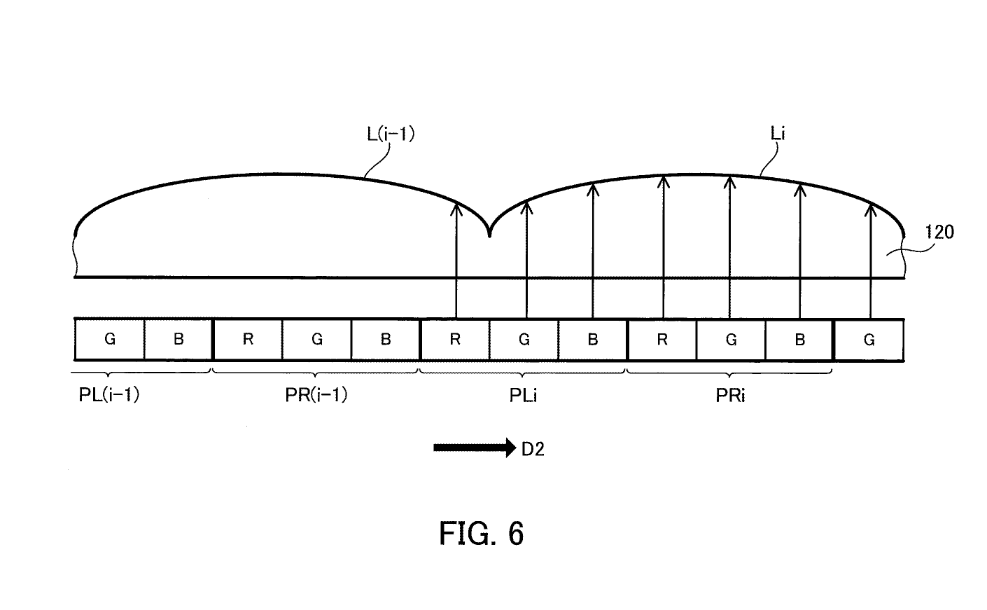

FIG. 6 illustrates an example of light paths when there is positional misalignment between the stereoscopic image and the lens sheet. For example, in FIG. 6, the stereoscopic image is misaligned by one pixel in the opposite direction (leftward in FIG. 6) to the direction D2 from the correct position.

In this case, reflected light from the G pixel and the B pixel of the i-th left-eye pixel group PLi and from all pixels of the right-eye pixel group PRi enters into the i-th cylindrical lens Li. However, reflected light from R pixel of the i-th left-eye pixel group PLi incorrectly enters into the (i−1)th cylindrical lens L(i−1). In this case, the viewer does not visually perceive a correct 3D image, but an image including crosstalk with a feeling of strangeness.

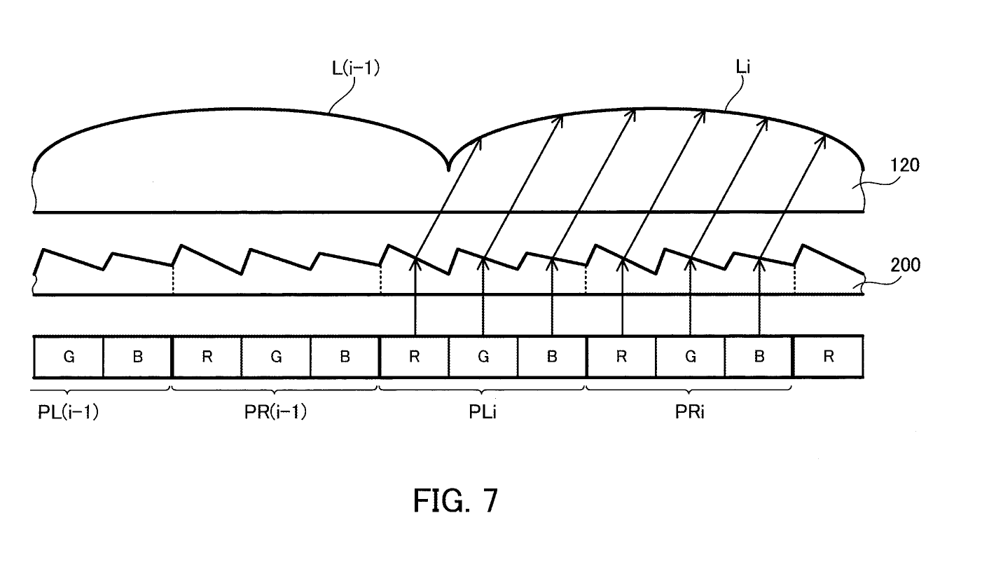

FIG. 7 illustrates an example of light paths when a diffraction grating sheet is inserted in the configuration of FIG. 6. When there is positional misalignment of one pixel as in FIG. 6, one diffraction grating sheet 200 is inserted between the print member 110 and the lens sheet 120.

The diffraction grating sheet 200 is located in such a manner that the diffraction gratings for R pixel, G pixel, and B pixel are positioned directly above the misaligned R pixel, G pixel, and B pixel, respectively. Accordingly, the light path of the reflected light from R pixel of the i-th left-eye pixel group PLi is changed by the diffraction grating for R pixel of the diffraction grating sheet 200, so that the reflected light enters into the i-th cylindrical lens Li. Thereby, the viewer recognizes the stereoscopic image as a 3D image.

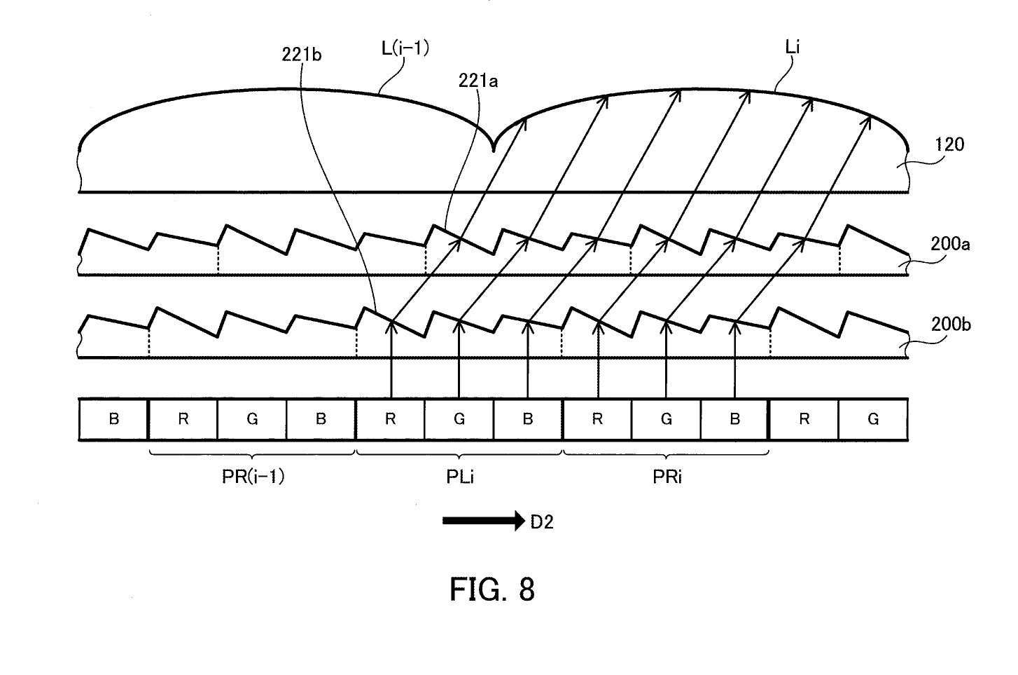

FIG. 8 illustrates an example of light paths when a plurality of diffraction grating sheets are inserted. In the example of FIG. 8, the stereoscopic image is misaligned from the correct position by two pixels in the opposite direction to the direction D2. In this case, two diffraction grating sheets are inserted between the print member 110 and the lens sheet 120. FIG. 8 illustrates diffraction grating sheets 200a and 200b that are inserted in order from the lens sheet 120.

The diffraction grating sheet 200b is located adjacent to the print member 110 in such a manner that the diffraction gratings for R pixel, G pixel, and B pixel are positioned directly above the misaligned R pixel, G pixel, and B pixel, respectively. Also, as for the diffraction grating sheet 200a and the diffraction grating sheet 200b, positions of the diffraction gratings of color components are shifted by one pixel. Specifically, a diffraction grating of a certain color in the diffraction grating sheet 200b is misaligned in the opposite direction to the direction D2 by one pixel from a diffraction grating of the same color in the diffraction grating sheet 200a.

The positions of the diffraction gratings of color components are shifted between the adjacent diffraction grating sheets 200a and 200b, so that a reflected light from a pixel of a certain color component unfailingly enters into a target cylindrical lens through diffraction gratings corresponding to the color. For example, in FIG. 8, the reflected light from the R pixel of the i-th left-eye pixel group PLi enters into the i-th cylindrical lens Li through the diffraction grating 221b for the R pixel in the diffraction grating sheet 200b and the diffraction grating 221a for the R pixel in the diffraction grating sheet 200a, which is shifted by one pixel to the direction D2 from the diffraction grating 221b.

This configuration enables the reflected light from the R pixel and the G pixel of the i-th left-eye pixel group PLi to enter into the i-th cylindrical lens Li via the diffraction grating sheets 200a and 200b. Thereby, the viewer recognizes the stereoscopic image as a 3D image.

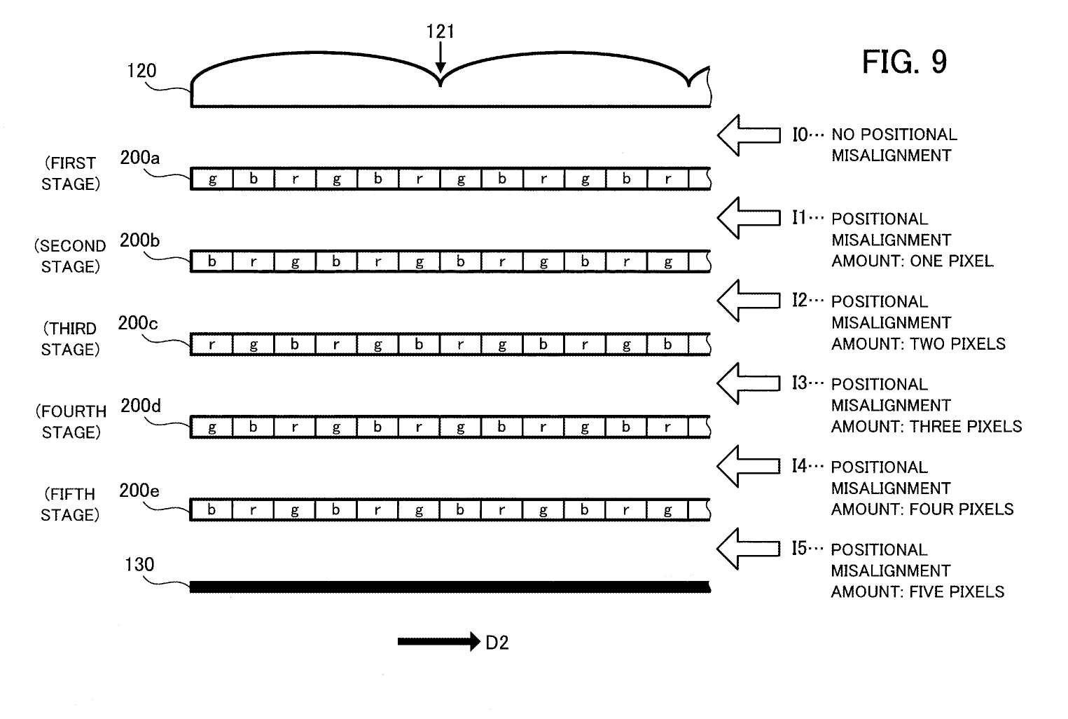

FIG. 9 illustrates position relationship between diffraction grating sheets with respect to diffraction gratings of color components. When each pixel group of the right eye image and the left eye image is composed of pixels of a number j which are adjacent in the direction D2, diffraction grating sheets 200 of a number (2j−1) at the maximum are inserted between the print member 110 and the lens sheet 120. In the present embodiment, as illustrated in FIG. 9, five diffraction grating sheets 200a to 200e are inserted at the maximum between the print member 110 and the lens sheet 120.

Also, in FIG. 9, “r”, “g”, and “b” illustrated on the respective diffraction grating sheets 200a to 200e indicate diffraction gratings for R pixel, diffraction gratings for G pixel, diffraction gratings for B pixel, respectively. As described above, the positions of the diffraction gratings of color components are shifted by one pixel from each other between the adjacent diffraction grating sheets.

When a pixel group includes a R pixel, a G pixel, and a B pixel arrayed in this order in the direction D2, the diffraction grating sheet 200a of the first stage closest to the lens sheet 120 is arranged in such a manner that the diffraction gratings for R pixel are shifted to the opposite direction (hereinafter, referred to as “−D2 direction”) to the direction D2 by one pixel from the boundary 121 of the cylindrical lens, for example. Also, the diffraction grating sheet 200b of the second stage is arranged in such a manner that the diffraction gratings for R pixel are shifted in −D2 direction by two pixels from the boundary 121 of the cylindrical lens. As for other stages as well, the diffraction grating sheets are arranged in such a manner that the diffraction gratings for R pixel in the diffraction grating sheets are shifted to −D2 direction as it gets closer to the print member 110.

As described above, the diffraction grating sheets are arranged in different ways depending on insert position. Thus, a plurality of types of diffraction grating sheets are in advance fabricated and prepared for each insert position, and when producing a 3D image displaying object 100, a diffraction grating sheet that matches to the insert position is selected.

Further, characteristics of respective diffraction gratings of the diffraction grating sheets are different depending on whether the member adjacent to the opposite side (hereinafter, referred to as “back side”) facing away from the lens sheet 120 is the print member 110 or another diffraction grating sheet. In FIG. 9, positions I0 to I5 are a variation of insert position of the print member 110, which is decided according to positional misalignment amount between the stereoscopic image and the lens sheet 120.

The position I0 indicates an insert position of the print member 110 when there is no positional misalignment to −D2 direction of the stereoscopic image relative to the lens sheet 120. The position I1, I2, I3, I4, and I5 indicate insert positions of the print member 110 when the positional misalignment amount to −D2 direction of the stereoscopic image relative to the lens sheet 120 are one pixel, two pixels, three pixels, four pixels, and five pixels, respectively.

When the print member 110 is inserted in the position I1 selected from among the above insert positions, the print member 110 is adjacent to the back side of the diffraction grating sheet 200a of the first stage. This configuration corresponds to the configuration of FIG. 7, for example. In contrast, when the print member 110 is inserted in the position I2, the diffraction grating sheet 200b of the second stage is adjacent to the back side of the diffraction grating sheet 200a of the first stage. This configuration corresponds to the configuration of FIG. 8, for example. Likewise, when the print member 110 is inserted in the positions I2 to I5, the diffraction grating sheet 200b of the second stage is adjacent to the back side of the diffraction grating sheet 200a of the first stage.

Here, when another diffraction grating sheet 200b is adjacent to the back side of the diffraction grating sheet 200a of the first stage, the light paths of the reflected light entering into the diffraction grating sheet 200a has been changed by the diffraction grating sheet 200b at the back side. Hence, the incident angle of the reflected light into the diffraction grating sheet 200a from the back side thereof is different when the print member 110 is adjacent to the back side, as compared to when another diffraction grating sheet 200b is adjacent to the back side. Thus, characteristics (for example, angles of the boundaries 221 to 223 illustrated in FIG. 4) of the diffraction gratings for respective colors in the diffraction grating sheet 200a need to be different when the print member 110 is adjacent to the back side, as compared to when another diffraction grating sheet 200b is adjacent to the back side.

Here, the diffraction grating sheet used when the print member 110 is adjacent to the back side is referred to as “diffraction grating sheet of first type”, and the diffraction grating sheet used when another diffraction grating sheet is adjacent to the back side is referred to as “diffraction grating sheet of second type”. As above, the diffraction grating sheets of both of the first type and the second type are prepared, as the diffraction grating sheet 200a of the first stage. As for the second to fourth stages, the diffraction grating sheets of both of the first type and the second type are prepared as well. As for the diffraction grating sheet 200e of the fifth stage, only the diffraction grating sheet of the first type is prepared.

Note that, in the diffraction grating sheet 200a of the first stage and the diffraction grating sheet 200d of the fourth stage, diffraction gratings of each color component are located at same positions, and therefore common diffraction grating sheets can be used as the first type and the second type. Likewise, common diffraction grating sheets can be used as the first-type diffraction grating sheet 200b of the second stage and the diffraction grating sheet 200e of the fifth stage.

Thus, in order to produce a 3D image displaying object 100 of the present embodiment, a total of six types of diffraction grating sheets are prepared in advance, which includes the diffraction grating sheets of the first type and the second type for the first stage and the fourth stage, the diffraction grating sheet of the first type for the second stage and the fifth stage, the diffraction grating sheet of the second type 200b for the second stage, and the diffraction grating sheets 200c of the first type and the second type for the third stage.

Note that, when the print member 110 is inserted at any of the positions I0 to I5, other diffraction grating sheets are needless to be located at the back side of the inserted print member 110, and the light shielding plate 130 may be bonded on the inserted print member 110. Note that, as another example, the 3D image displaying object 100 may be configured such that the five diffraction grating sheets 200a to 200e are stacked regardless of positional misalignment amount of the stereoscopic image, and the print member 110 is inserted into one of the positions I0 to I5, depending on the positional misalignment amount. In this case, the thickness of the 3D image displaying object 100 is constant, regardless of positional misalignment amount. Also, a same process may be used for stacking the diffraction grating sheets and bonding them with pressure, and same production equipment may be used in that process, regardless of positional misalignment amount.

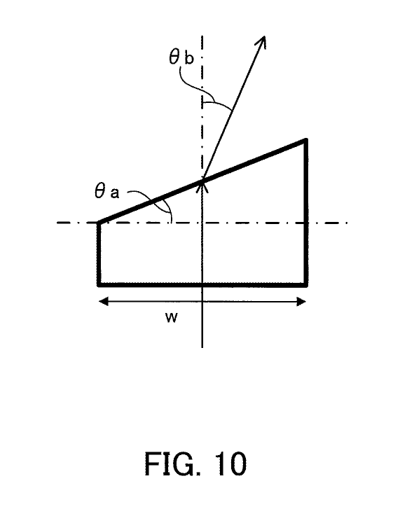

Next, an exemplary design of the 3D image displaying object 100 will be described with reference to FIGS. 10 to 12. FIG. 10 is a diagram for describing a transmissive blazed diffraction grating. In the diffraction grating sheets 200, λ represents the wavelength of incident light into the diffraction grating, and θa represents the blaze angle of the diffraction grating, and θb represents the angle of outgoing light relative to the incident light, and N represents the number of gratings per 1 mm, and w represents the width of the diffraction grating, and m represents the diffraction order. Note that the blaze angle θa corresponds to angles of the boundaries 221 to 223 in each diffraction gratings 201 to 203 illustrated in FIG. 4.

In this case, an equation sin θb=Nmλ is established. This equation is transformed into (cos θb)²=1−(sin θb)². On the other hand, Snell's law establishes an equation w·sin θa=sin(θa+θb). This equation is transformed into w·sin θa=sin θa·cos θb+cos θa·sin θb. Next equation (1) is derived from equations described above.

w·sin θa=sin θa{\sqrt{1−(N·m·λ)²}}+cos θa·N·m·λ (1)

For example, the wavelength λr of reflected light from R pixel is 660 nm, and the wavelength λg of reflected light from G pixel is 520 nm, and the wavelength λb of reflected light from B pixel is 470 nm, and the width w of diffraction grating is 0.415 mm, which is same as the pixel width of the printed stereoscopic image, and the number N of gratings is 600, which is a commonly-used value, and the diffraction order m is “1”. The value of “root” term in the equation (1) can be assumed to be “1” at any wavelength. In this case, the blaze angles θa_r, θa_g, and θa_b of the diffraction gratings for R pixel, G pixel, and B pixel are calculated at the following values from the equation (1).

θa_{—}r=−0.0388

θa_{—}g=−0.0306

θa_{—}b=−0.0276

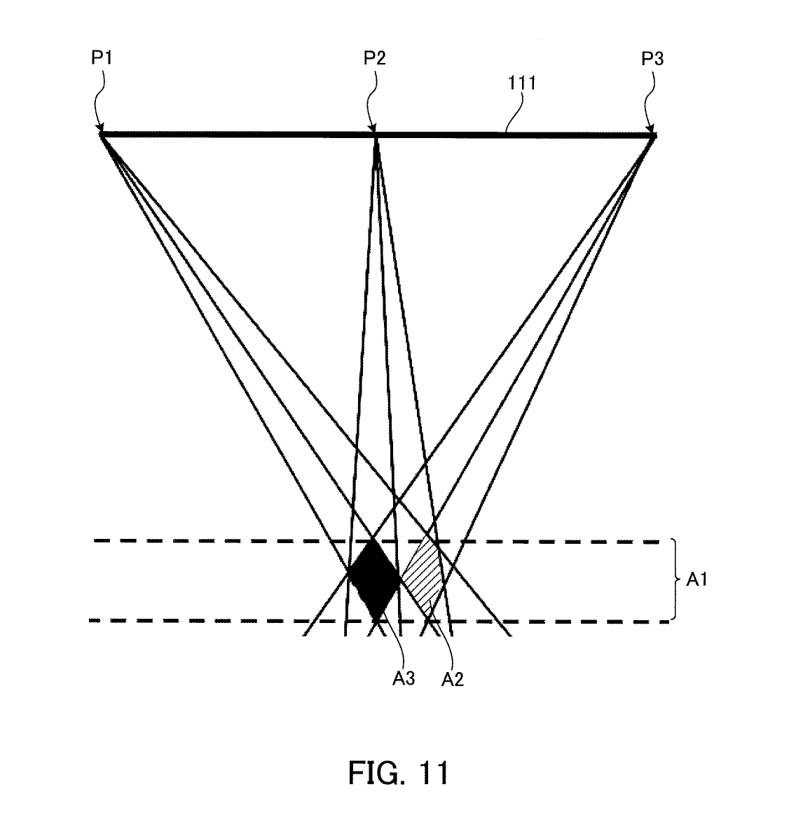

FIG. 11 illustrates an example of view zones of the right eye image and the left eye image. For example, FIG. 11 illustrates view zones for pixel groups P1 to P3 on the stereoscopic image 111. Note that each of the pixel groups P1 to P3 is a pair of a right-eye pixel group and a left-eye pixel group.

The lenticular lens collect reflected light from the right-eye pixel group and the left-eye pixel group of the pixel group P1 within a predetermined range of angle θ. Also, the lenticular lens collects reflected light from the right-eye pixel group and the left-eye pixel group of the pixel group P2, and reflected light from the right-eye pixel group and the left-eye pixel group of the pixel group P3, within a range of angle θ in the same way.

An image formation area A1 of a constant width which is positioned a predetermined distance away from the stereoscopic image 111 includes a right-eye view zone A2 where reflected light from the right-eye pixel groups of the pixel groups P1 to P3 forms an image, and a left-eye view zone A3 where reflected light from the left-eye pixel groups of the pixel groups P1 to P3 forms an image. When the right eye of a viewer is positioned in the right-eye view zone A2, and the left eye is positioned in the left-eye view zone A3, the viewer visually perceives the stereoscopic image 111 as a 3D image.

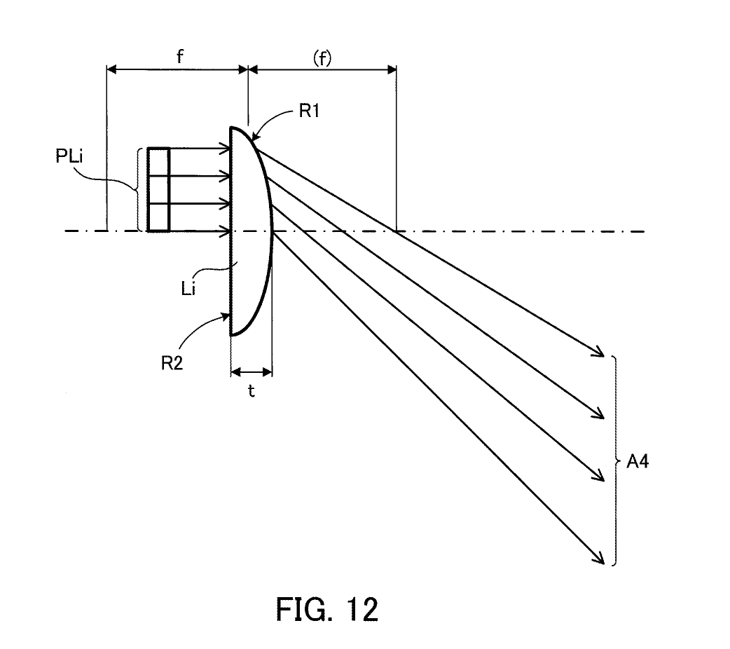

FIG. 12 is a diagram for describing a view zone formed by a lenticular lens. For example, FIG. 12 illustrates a view zone corresponding to the left-eye pixel group PLi in the stereoscopic image. Reflected light from the left-eye pixel group PLi is refracted by the corresponding cylindrical lens Li, and thereby a view zone A4 of the left-eye pixel group PLi is formed.

Here, R1 represents the curvature radius of each cylindrical lens seen from the stereoscopic image, and R2 represents the curvature radius of each cylindrical lens seen from the viewer, and f represents the focal length of each cylindrical lens of the side facing the stereoscopic image, and n represents the refractive index of each cylindrical lens, and t represents the thickness of each cylindrical lens. In this case, next equation (2) is obtained.

1/f=(n−1)·(1/R1−1/R2)+(n−1)·{(n−1)/n}·t/(R1·R2) (2)

In the present embodiment, the cylindrical lens is a plano-convex lens, and therefore the curvature radius R2 is infinite, and 1/R2 is “0”. Also, t/(R1·R2) is “0”. Thus, the above equation (2) is transformed into 1/f=(n−1)·(1/R1). The refractive index n is a fixed value decided by material of the cylindrical lens, and therefore the value of the focal length f is dependent on the curvature radius R1.

In this case, a distance p from the principal point of the cylindrical lens to a viewer is set longer than 0 and shorter than f, so that pixels of the stereoscopic image form an image in the image formation area of a predetermined width positioned at a constant distance from the cylindrical lens. Next equation (3) is obtained.

tan(90−θ)=3q/f=3q·(r−1)/R1 (3)

where θ is the angle of image formation area with respect to a pixel as a base point (which corresponds to the angle θ in FIG. 11), and q is the pixel width.

For example, assuming that the angle θ is 30°, and the refractive index n is “2”, the equation (3) results in R1=0.719.

Next, an example of a production method of the 3D image displaying object 100 will be described. As described in FIG. 9, the diffraction grating sheets include an array of diffraction gratings having different characteristics for each color component. Hence, if the print member 110 is located at a position selected from the positions I0 to I5 of FIG. 9 where the positional misalignment of the stereoscopic image does not match to the located position, the viewer visually perceives an image of incorrect colors, and has a feeling of strangeness. Such cases occur, for example, when there is no positional misalignment, or when the located print member 110 has a positional misalignment of two to five pixels despite the print member 110 located at the position I1.

Thus, when producing a 3D image displaying object 100, a worker fabricates a plurality of 3D image displaying objects (hereinafter, referred to as “pilot displaying object”) in each of which the print member 110 having a stereoscopic image printed thereon is located at each positions I0 to I5, for example. The worker visually perceives these pilot displaying objects to find a pilot displaying object having the print member 110 located at a correct position, so that the worker can determine the position to locate the print member 110 in the 3D image displaying object 100 that is prepared for shipment.

Also, dedicated images may be printed on the pilot displaying object to determine more clearly whether or not the position of the print member 110 is correct. In the following, an example of such dedicated marker images will be described.

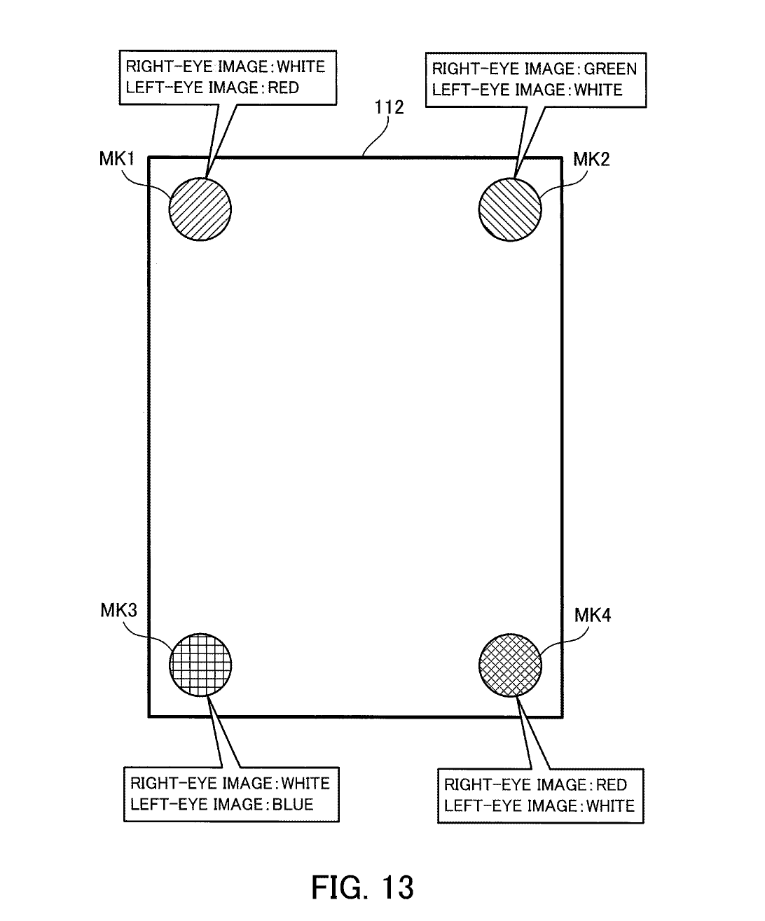

FIG. 13 illustrates an example of marker images used in producing a 3D image displaying object. FIG. 13 illustrates a print member 112 for determining a position (hereinafter, referred to as “pilot print member”), on which marker images MK1 to MK4 of four types are printed, for example. Each of the marker images MK1 to MK4 includes a right eye image and a left eye image of different colors, and color combinations of the right eye image and the left eye image are different from each other in all of the marker images MK1 to MK4.

In the present embodiment, the color combinations in the marker images MK1 to MK4 are as described next. In the marker image MK1, the right eye image is white, and the left eye image is red. In the marker image MK2, the right eye image is green, and the left eye image is white. In the marker image MK3, the right eye image is white, and the left eye image is blue. In the marker image MK4, the right eye image is red, and the left eye image is white.

In the following example, a pilot displaying object includes the pilot print member 112 at the position I0 of FIG. 9, and the marker images MK1 to MK4 are printed on the pilot print member 112. In this case, when there is no positional misalignment between the marker images MK1 to MK4 and the lens sheet 120, the worker visually perceives the marker images MK1 to MK4 as described next. When observing the pilot displaying object by the right eye while closing the left eye, the worker recognizes the marker images MK1, MK2, MK3, and MK4 to be white, green, white, and red, respectively. Also, when observing the pilot displaying object by the left eye while closing the right eye, the worker recognizes the marker images MK1, MK2, MK3, and MK4 to be red, white, blue, and white, respectively. On the other hand, when there is positional misalignment between the marker images MK1 to MK4 and the lens sheet 120, the marker images MK1 to MK4 are observed differently from the above.

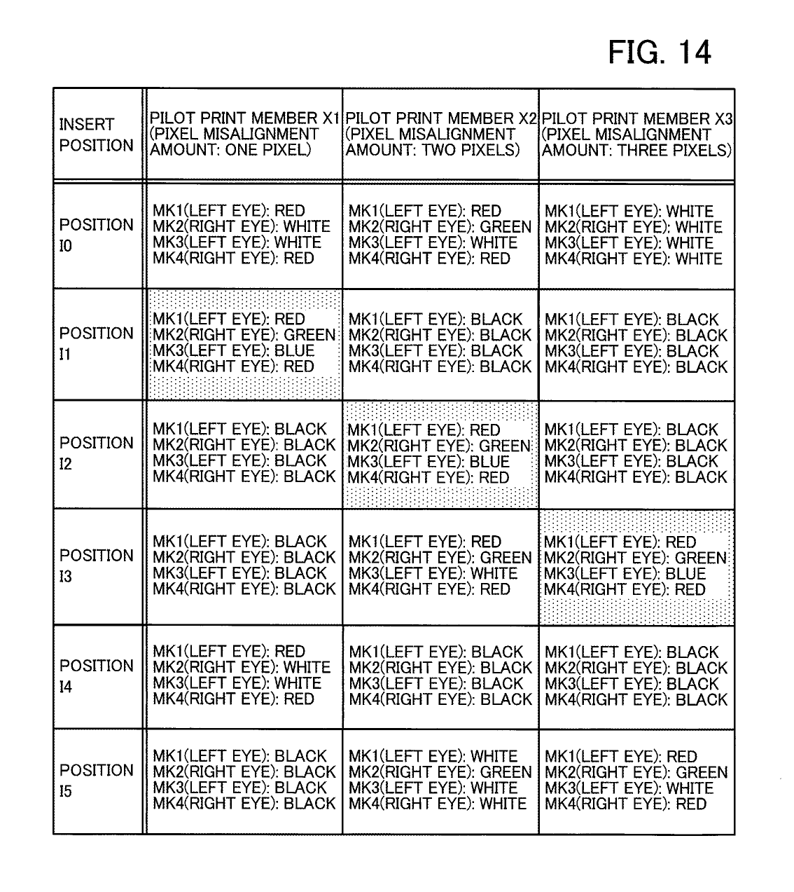

FIG. 14 illustrates how the marker images are viewed under conditions of positional misalignment amount. FIG. 14 illustrates how the marker images MK1 to MK4 are viewed when the pilot print members X1, X2, and X3 are inserted into each of the positions I0 to I5, for example

Here, in the pilot print members X1, X2, and X3, the positional misalignment amounts to −D2 direction of the marker images MK1 to MK4 relative to the lens sheet 120 are one pixel, two pixels, and three pixels respectively. Also, FIG. 14 illustrates combinations of the color of the marker image MK1 viewed by left eye, the color of the marker image MK2 viewed by right eye, the color of the marker image MK3 viewed by left eye, and the color of the marker image MK4 viewed by right eye, for example.

When the pilot print member 112 is located at the correct position, the combination of the color of the marker image MK1 viewed by left eye, the color of the marker image MK2 viewed by right eye, the color of the marker image MK3 viewed by left eye, and the color of the marker image MK4 viewed by right eye is (red, green, blue, red). When the worker visually perceives other color combination of the marker images MK1 to MK4, the position of the pilot print member 112 is incorrect. In the example of FIG. 14, the correct insert position of the pilot print member X1 is the position I1, and the correct insert position of the pilot print member X2 is the position I2, and the correct insert position of the pilot print member X3 is the position I3.

Thus, for example, the worker fabricates pilot displaying objects in which the pilot print members 112 are located at the positions I0 to I5. Then, the worker visually perceives the fabricated pilot displaying objects to find a pilot displaying object in which the pilot print member 112 is inserted at the correct position from among the above pilot displaying objects. Thereby, the worker easily finds the correct position to insert the pilot print member 112.

Also, the worker can determine the correct position to insert the pilot print member 112 by fabricating one pilot displaying object in which the pilot print member 112 is located at one of the positions I0 to I5.

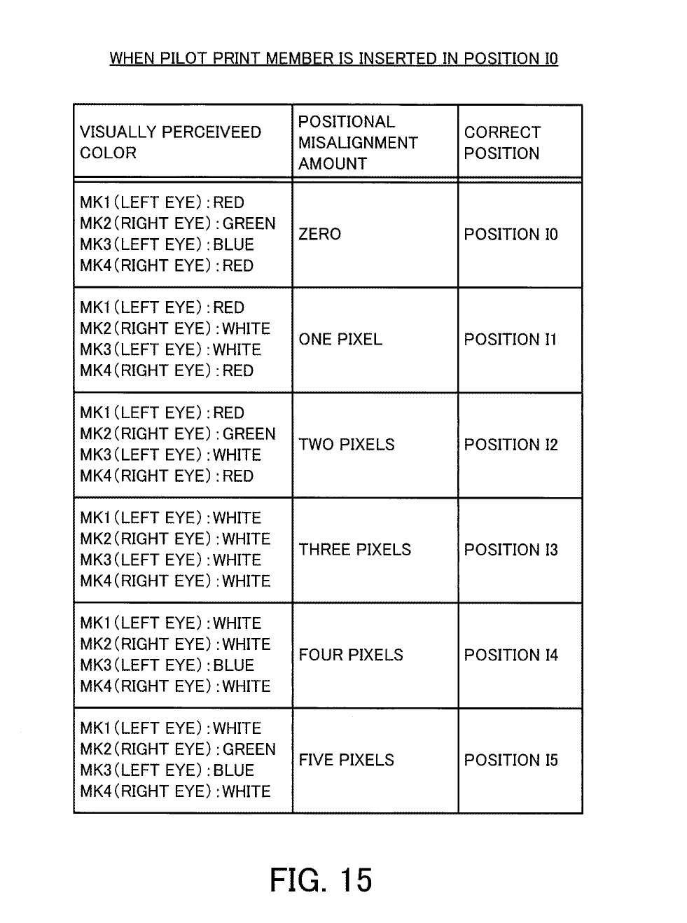

FIG. 15 illustrates a relationship between colors of the marker images and positional misalignment amounts in a pilot displaying object. In FIG. 15, the pilot print member 112 is inserted in the position I0, and the marker images MK1 to MK4 of FIG. 13 are printed on the pilot print member 112, for example.

FIG. 15 illustrates combinations of the color of the marker image MK1 viewed by left eye, the color of the marker image MK2 viewed by right eye, the color of the marker image MK3 viewed by left eye, and the color of the marker image MK4 viewed by right eye, and these combinations are different from each other, depending on positional misalignment amount. Thus, the worker fabricates one pilot displaying object and observes the colors of the marker images MK1 to MK4 on the pilot print member 112 inserted in the pilot displaying object, in order to determine the correct position to insert the pilot print member 112. Also, since the insert position of the print member is determined by fabricating one pilot displaying object, work efficiency is improved.

Note that the marker images described in FIGS. 13 to 15 are just examples, and color, shape, position, etc of each marker image may be changed as appropriate.

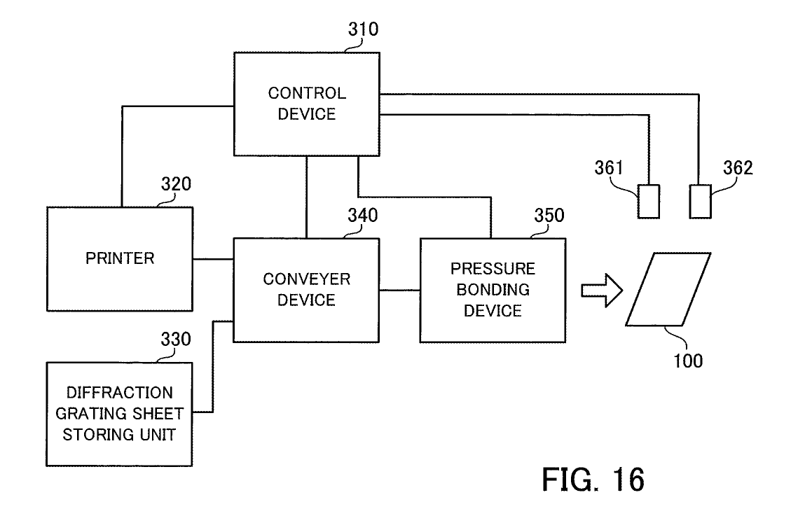

Next, FIG. 16 illustrates an exemplary configuration of a production system of the 3D image displaying object. The production system illustrated in FIG. 16 is an example of devices for producing the 3D image displaying object 100 that is configured such that the five diffraction grating sheets 200a to 200e are stacked between the lens sheet 120 and the light shielding plate 130 as illustrated in FIG. 9, and the print member 110 is inserted at one of the positions I0 to I5. This production system includes a control device 310, a printer 320, a diffraction grating sheet storing unit 330, a conveyer device 340, a pressure bonding device 350, and cameras 361 and 362.

The control device 310 centrally controls the entire system. Also, the control device 310 has a function for outputting image data of an image that is to be printed on the print member 110, to the printer 320. Note that another device may have the function for outputting an image data. Note that the control device 310 is configured by a computer including a processor, a memory, etc, for example.

The printer 320 receives an instruction from the control device 310, and prints an image on the print member 110 on the basis of image data received from the control device 310.

The diffraction grating sheet storing unit 330 stores a plurality of diffraction grating sheets 200, which are to be located at the positions I0 to I5 illustrated in FIG. 9. As described above, the diffraction grating sheet storing unit 330 prepares and stores a total of six types of the diffraction grating sheets 200, which includes diffraction grating sheets of the first type and the second type for the first stage and the fourth stage, diffraction grating sheets of the first type for the second stage and the fifth stage, diffraction grating sheets of the second type for the second stage, and diffraction grating sheets of the first type and the second type for the third stage.

The conveyer device 340 conveys the lens sheet 120, the print member 110 on which an image is printed by the printer 320, the diffraction grating sheets 200 stored in the diffraction grating sheet storing unit 330, and the light shielding plate 130, to the pressure bonding device 350. Note that FIG. 16 omits storage units of the lens sheet 120 and the light shielding plate 130.

Conveyance paths from the conveyer device 340 to the pressure bonding device 350 include a conveyance path of the lens sheet 120, a conveyance path of the light shielding plate 130, conveyance paths of the diffraction grating sheets 200 of the first to fifth stages illustrated in FIG. 9, and conveyance paths of the print member 110 to the positions I0 to I5 of FIG. 9. The conveyer device 340 selectively conveys a diffraction grating sheet 200 of the type specified by the control device 310 from among the diffraction grating sheets 200 stored in the diffraction grating sheet storing unit 330, through the conveyance paths of the diffraction grating sheets 200 of the first to fifth stages. Also, the conveyer device 340 selectively conveys the print member 110 to one of the positions I0 to I5.

The lens sheet 120, the diffraction grating sheets 200, the print member 110, and the light shielding plate 130 are each conveyed by the conveyer device 340 and fixed with each other by thermocompression bonding in the pressure bonding device 350. Also, the pressure bonding device 350 includes a function for applying adhesive agent on the fixation surfaces of these components.

Each of the cameras 361 and 362 captures an image of a display surface of the 3D image displaying object 100 fabricated by the pressure bonding device 350. The interval of the cameras 361 and 362 is set at an average interval between viewer's eyes. Assuming that the camera 361 corresponds to the right eye of the viewer, and the camera 362 corresponds to the left eye of the viewer, the cameras 361 and 362 are directed toward the display surface of the 3D image displaying object 100 so as to be positioned in the right-eye view zone and the left-eye view zone respectively, from which the stereoscopic image of the 3D image displaying object 100 is recognized as a 3D image.

The cameras 361 and 362 are provided to capture an image of the marker images MK1 to MK4 illustrated in FIG. 13. Captured image signals of the marker images MK1 to MK4 captured by the cameras 361 and 362 are transmitted to the control device 310. The control device 310 determines the insert position of the print member 110 in the 3D image displaying object 100 on the basis of the correspondence relationship of FIG. 15, using the captured image signal. Then, on the basis of the determination result, the control device 310 causes the conveyer device 340 to convey the print member 110 for the 3D image displaying object 100 for shipment, to the correct position. In addition, the control device 310 causes the conveyer device 340 to convey the diffraction grating sheets 200 of suitable type from the diffraction grating sheet storing unit 330.

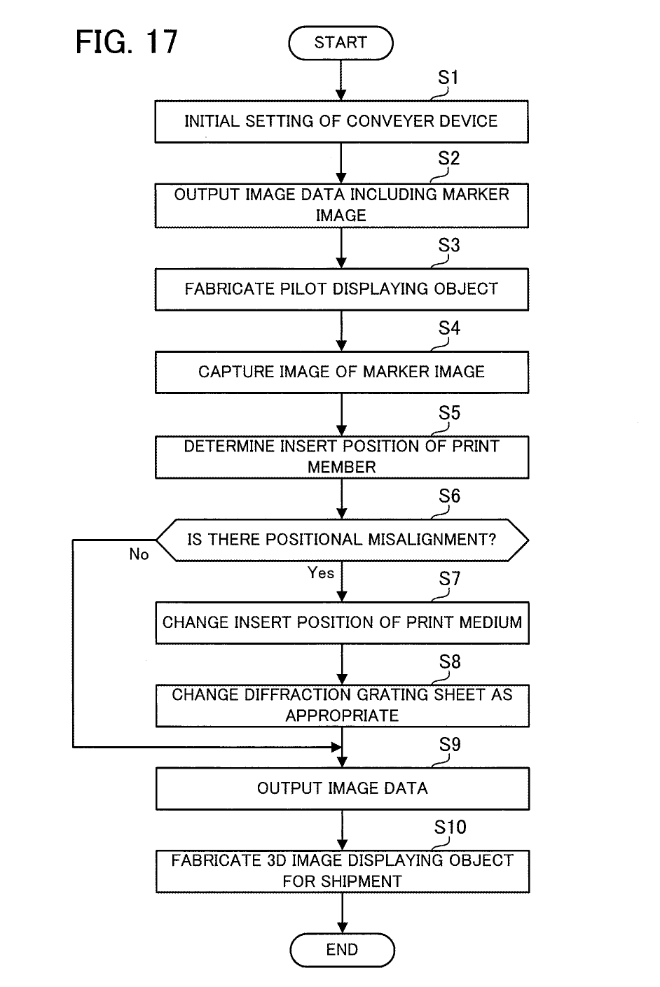

FIG. 17 is a flowchart illustrating an example of a production process of the 3D image displaying object. In FIG. 17, steps S1 to S3 are a production process of the aforementioned pilot displaying object, and steps S4, S5 are a process for determining the insert position of the print member 110, and steps S6 to S10 are a production process of a 3D image displaying object for shipment.

[Step S1] The control device 310 executes initial setting of the conveyer device 340. In an example of FIG. 17, the insert position of the pilot print member in the pilot displaying object is set at the position I0 of FIG. 9. In this case, the control device 310 instructs the conveyer device 340 to convey the print member from the printer 320 to the position I0. Also, the control device 310 instructs the conveyer device 340 to locate the diffraction grating sheets 200 as described next.

First to the fourth stages: diffraction grating sheets of the second type of the corresponding stages.

Fifth stage: a diffraction grating sheet of the first type of the corresponding fifth stage.

A combination of diffraction grating sheets 200 positioned as above reduces the number of the diffraction grating sheets that are later changed when fabricating the 3D image displaying object for shipment.

[Step S2] The control device 310 outputs image data of the image including the marker images MK1 to MK4 to the printer 320. Then, the control device 310 instructs the printer 320, the conveyer device 340, and the pressure bonding device 350 to start fabricating a 3D image displaying object (here, pilot displaying object).

[Step S3] The printer 320, the conveyer device 340, and the pressure bonding device 350 operate to fabricate a pilot displaying object in which the pilot print member is located at the position I0.

[Step S4] The control device 310 instructs the cameras 361 and 362 to capture an image of the fabricated pilot displaying object. Each of the cameras 361 and 362 captures an image of the pilot displaying object and outputs the captured image data to the control device 310. In this case, the camera 361 captures a right eye image (i.e., right-eye components of the marker images MK1 to MK4), and the camera 362 captures a left eye image (i.e., left-eye components of the marker images MK1 to MK4).

[Step S5] The memory device of the control device 310 stores in advance a data table indicating the correspondence relationship between colors and positions illustrated in FIG. 15. The control device 310 determines the colors of the marker images MK1 to MK4 on the basis of the image data received from the cameras 361 and 362, and determines the correct insert position of the print member on the basis of the correspondence relationship recorded in the data table.

[Step S6] If there is positional misalignment of pixels (i.e., when the correct insert position is not the position I0), the control device 310 executes the process of step S7. On the other hand, if there is no positional misalignment of pixels (i.e., when the correct insert position is the position I0), the control device 310 executes the process of step S9.

[Step S7] The control device 310 causes the conveyer device 340 to change the insert position of the print member to the position determined in step S5.

[Step S8] The control device 310 instructs the conveyer device 340 to change one of the diffraction grating sheets of the first to fourth stages, to a diffraction grating sheet of the first type, on the basis of the determination result of the insert position in step S5. Specifically, when the insert position is the position I1, the control device 310 changes the diffraction grating sheet of the first stage from the second type to the first type. When the insert position is the position I2, the control device 310 changes the diffraction grating sheet of the second stage from the second type to the first type. When the insert position is the position I3, the control device 310 changes the diffraction grating sheet of the third stage from the second type to the first type. When the insert position is the position I4, the control device 310 changes the diffraction grating sheet of the fourth stage from the second type to the first type. As described above, in step S8, only one of the diffraction grating sheets is changed in its type, among the diffraction grating sheets which have been set in step S1.

[Step S9] The control device 310 outputs image data including a product image to the printer 320. Then, the control device 310 instructs the printer 320, the conveyer device 340, and the pressure bonding device 350 to start fabricating a 3D image displaying object for shipment.

[Step S10] The printer 320, the conveyer device 340, and the pressure bonding device 350 operate to fabricate a 3D image displaying object in which a print member is located at the position determined in step S5. Note that the control device 310 may specify the number of the 3D image displaying objects in order to fabricate them consecutively in step S10.

According to the above production process, even when there is misalignment in the image printed by the printer 320, a produced 3D image displaying object allows a viewer to perceive its 3D image correctly. Thereby, for example, even when the printers 320 print an image at different printing positions on the print member (particularly, positions of pixel units of each color component), a produced 3D image displaying object allows a viewer to perceive its 3D image correctly. That is, regardless of the model of the printer 320, a produced 3D image displaying object allows a viewer to perceive its 3D image correctly. Also, even when the image printing position on the print member is changed by the setting or the adjustment method of the printer 320, a produced 3D image displaying object allows a viewer to perceive its 3D image correctly.

Also, according to the production process of FIG. 17, since as many diffraction grating sheets are stacked in every produced 3D image displaying object, the thickness of every produced image displaying object is constant. In addition, since the same production process is used, except for steps S7 and S8, regardless of positional misalignment amount of the stereoscopic image, its production efficiency is improved.

Note that each of the above embodiments has described what is called “two-view 3D image displaying object” with which the viewer visually perceives one stereoscopic image including a pair of right eye image and left eye image. However, the 3D image displaying object of the above embodiments may be modified and adapted for a four-view method or a six-view method in order to allow the viewer to visually perceive a plurality of images whose viewpoints are different from each other.

According to one aspect, a 3D image is visually perceived even when there is positional misalignment between the lenticular lens and the printed image.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A 3D image displaying object, comprising:
a print member on which a stereoscopic image including a right eye image and a left eye image is printed;
a lenticular lens including an array of a plurality of cylindrical lenses for converging a reflected light from the right eye image and a reflected light from the left eye image at respective different view zones; and
one or a plurality of optical members located between the print member and the lenticular lens, and including a plurality of optical elements that correspond to pixels of color components of the right eye image and pixels of color components of the left eye image which are arrayed in an array direction of the cylindrical lenses,
wherein each of the optical elements bends a light path of the reflected light that comes from a corresponding pixel of the stereoscopic image and enters into the lenticular lens, in the array direction.

2. The 3D image displaying object according to claim 1, wherein
each of the optical elements bends the light path of the reflected light that comes from the corresponding pixel so as to shift a position at which the reflected light from the corresponding pixel enters into the lenticular lens, according to a number of pixels of positional misalignment between the lenticular lens and the stereoscopic image in the array direction.

3. The 3D image displaying object according to claim 1, wherein
the plurality of optical members are located between the print member and the lenticular lens, and
each of the optical elements bends the light path of the reflected light from the stereoscopic image so as to shift a position at which the reflected light from the stereoscopic image enters into another optical member or the lenticular lens adjacent in a light exiting direction by one pixel, and
a number of the optical members is same as a number of the pixels of a positional misalignment between the lenticular lens and the stereoscopic image in the array direction.

4. The 3D image displaying object according to claim 1, wherein
a predetermined number of the optical members are located in a space where the reflected light from the stereoscopic image travels before entering into the lenticular lens, wherein the predetermined number is equal to or greater than two,
each of the optical elements bends the light path of the reflected light from the stereoscopic image so as to shift a position at which the reflected light from the stereoscopic image enters into another optical member or the lenticular lens adjacent in a light exiting direction by one pixel, and
the print member is located on a stack of the optical members as many as pixels of positional misalignment between the lenticular lens and the stereoscopic image in the array direction, the optical members being stacked on the lenticular lens.

5. A production method of a 3D image displaying object including a print member on which a stereoscopic image including a right eye image and a left eye image is printed, and a lenticular lens including an array of a plurality of cylindrical lenses for converging a reflected light from the right eye image and a reflected light from the left eye image at respective different view zones, the production method comprising:
stacking one or a plurality of optical members having a plurality of optical elements corresponding to pixels of color components of the right eye image and pixels of color components of the left eye image which are arrayed in an array direction of the cylindrical lenses, between the print member and the lenticular lens,
wherein each of the optical elements bends a light path of the reflected light that comes from a corresponding pixel of the stereoscopic image and enters into the lenticular lens, in the array direction.

6. The production method of the 3D image displaying object according to claim 5, wherein
the stacking includes stacking the one or a plurality of optical members as many as pixels of positional misalignment between the lenticular lens and the stereoscopic image in the array direction, between the print member and the lenticular lens, and
each of the optical elements bends the light path of the reflected light from the stereoscopic image so as to shift a position at which the reflected light from the stereoscopic image enters into another optical member or the lenticular lens adjacent in a light exiting direction by one pixel.

7. The production method of the 3D image displaying object according to claim 5, comprising:
printing on a first print member a first stereoscopic image including a plurality of marker images each having different colors as the right eye image and the left eye image by means of a printer, wherein combinations of the colors of the right eye image and the left eye image in the marker images are different from each other;
fabricating a first 3D image displaying object by stacking a predetermined number of the optical members between the first print member and the lenticular lens;
determining a positional misalignment amount between the lenticular lens and the first stereoscopic image in the array direction on the basis of a result of visual perception, or a captured image, of the marker images on the first 3D image displaying object;
printing a second stereoscopic image on a second print member by means of the printer; and
fabricating a second 3D image displaying object by stacking the optical members as many as pixels of the determined positional misalignment amount, between the second print member and the lenticular lens,
wherein each of the optical elements bends the light path of the reflected light from the first or second stereoscopic image so as to shift a position at which the reflected light from the first or second stereoscopic image enters into another optical member or the lenticular lens adjacent in a light exiting direction by one pixel.

8. The production method of the 3D image displaying object according to claim 5, wherein
printing on a first print member a first stereoscopic image including a plurality of marker images each having different colors as the right eye image and the left eye image by means of a printer, wherein combinations of the colors of the right eye image and the left eye image in the marker images are different from each other;
fabricating a first 3D image displaying object by locating a predetermined number of the optical members, which is equal to or greater than two, in a space that one surface of the lenticular lens faces toward, and locating the first print member at a predetermined position selected from an adjacent position to the surface of the lenticular lens and an adjacent positions to the optical members at an side away from the lenticular lens;
determining a positional misalignment amount between the lenticular lens and the first stereoscopic image in the array direction on the basis of a result of visual perception, or a captured image, of the marker images on the first 3D image displaying object;
printing a second stereoscopic image on a second print member by means of the printer; and
fabricating a second 3D image displaying object by locating the predetermined number of the optical members, which is equal to or greater than two, in the space that the surface of the lenticular lens faces toward, and locating the second print member at a position where the optical members as many as pixels of the determined positional misalignment are located between the second print member and the lenticular lens,
wherein each of the optical elements bends the light path of the reflected light from the first or second stereoscopic image so as to shift a position at which the reflected light from the first or second stereoscopic image enters into another optical member or the lenticular lens adjacent in the light exiting direction by one pixel.

9. A production system for producing a 3D image displaying object including a print member on which a stereoscopic image including a right eye image and a left eye image is printed, and a lenticular lens including an array of a plurality of cylindrical lenses for converging a reflected light from the right eye image and a reflected light from the left eye image at respective different view zones, the production system comprising:
a stacking device configured to fabricate a 3D image displaying object by stacking one or a plurality of optical members having a plurality of optical elements corresponding to pixels of color components of the right eye image and pixels of color components of the left eye image which are arrayed in an array direction of the cylindrical lenses, between the print member and the lenticular lens,
wherein each of the optical elements bends a light path of the reflected light that comes from a corresponding pixel of the stereoscopic image and enters into the lenticular lens, in the array direction.

10. The production system according to claim 9, wherein
the stacking device stacks the one or a plurality of optical members as many as pixels of positional misalignment between the lenticular lens and the stereoscopic image in the array direction, between the print member and the lenticular lens, and
each of the optical elements bends the light path of the reflected light from the stereoscopic image so as to shift a position at which the reflected light from the stereoscopic image enters into another optical member or the lenticular lens adjacent in a light exiting direction by one pixel.

11. The production system according to claim 9, further comprising:
a first and second image capturing devices each configured to capture the right eye image and the left eye image on the 3D image displaying object fabricated by the stacking device, respectively; and
a determination device configured to determine a positional misalignment amount between the lenticular lens and the stereoscopic image in the array direction, on the basis of images captured by the first and second image capturing devices,
wherein the stacking device
fabricates a first 3D image displaying object by locating a predetermined number of the optical members, which is equal to or greater than two, in a space that one surface of the lenticular lens faces toward, and locating a first print member on which a first stereoscopic image including a plurality of marker images each having different colors as the right eye image and the left eye image is printed, at a predetermined position selected from an adjacent position to the surface of the lenticular lens and an adjacent positions to the optical members at an side away from the lenticular lens, wherein combinations of the colors of the right eye image and the left eye image in the marker images are different from each other,
and thereafter fabricates a second 3D image displaying object by locating a predetermined number of the optical members, which is equal to or greater than two, in the space that the surface of the lenticular lens faces toward, and locating a second print member on which a second stereoscopic image is printed, at a position where the optical members as many as pixels of the determined positional misalignment are located between the second print member and the lenticular lens, and
each of the optical elements bends the light path of the reflected light from the first or second stereoscopic image so as to shift a position at which the reflected light from the first or second stereoscopic image enters into another optical member or the lenticular lens adjacent in the light exiting direction by one pixel, and
the determination device determines the positional misalignment amount on the basis of images of the first 3D image displaying object captured by the first image capturing device and the second image capturing device, and instructs the stacking device to locate the second print member at a position in the second 3D image displaying object based on the determined positional misalignment amount.
